(19) United States
(12) Patent Application Publication
(10) Pub. No.: US 2012/0170412 A1
(43) Pub. Date: Jul. 5, 2012

(54) Systems and methods including audio download and/or noise incident identification features

(76) Inventors: Robert B. Calhoun, Oberlin, OH (US); David A. Rochberg, Akron, OH (US); Elecia C. White, San Jose, CA (US); Jason W. Dunham, San Francisco, CA (US)

(21) Appl. No.: 11/973,336

(22) Filed: Oct. 4, 2007

Related U.S. Application Data
(60) Provisional application No. 60/849,593, filed on Oct. 4, 2006.

(51) Int. Cl. G01S 3/80

(52) U.S. Cl. 367/118

(57) ABSTRACT

Systems and methods are disclosed that detect weapon firing/noise incidents in a region and/or include other related features. According to one or more embodiments, an exemplary method may include detecting acoustic signals from the region by one or more sensors, processing the detected acoustic signals to generate a processed signal, storing the detected acoustic signals with each sensor, and processing the processed signal associated with each sensor to determine if a weapon firing incident occurred. Moreover, exemplary methods may include, if unable to determine whether a weapon firing incident occurred, performing further processing of the acoustic signals and/or determining if a weapon firing incident occurred based upon the stored detected acoustic signals.

### CROSS REFERENCE TO RELATED APPLICATIONS

This is a continuation of and claims priority to U.S. provisional patent application No. 60/849,593, filed Oct. 4, 2006, which is incorporated herein by reference.

### BACKGROUND

1. Field

The present invention relates generally to systems and methods for detecting and performing processing associated with noise and/or weapon fire incidents, such as those related to locating gunshot events in real time.

2. Description of Related Information

An urban gunshot location system has to detect gunfire in a complex and noisy acoustic environment. Because of the plethora of sounds present, a method is needed to discard the majority of non-explosive sounds and concentrate on sounds that can eventually be classified as gunfire. That problem was addressed in U.S. Pat. No. 5,973,998 “Automatic Real-Time Gunshot Locator and Display System,” which is incorporated herein by reference. A key idea disclosed therein is the “spatial filter” concept, wherein widely-spaced sensors detect only sounds loud enough to traverse the large distances between several sensors. An effective gunshot location system includes audio sensors able to detect impulses abrupt enough to be gunfire, synchronization and timing components to determine relative arrival times between sensors of single shots or multiple gunfire, and a location processor to triangulate events depending on the arrival times and to confirm from redundant sensor timings an event location or to discard inconsistent sensor times (as would arise from echoes). An effective system also includes a visual and auditory presentation to a user of confirmed events on a map which may include a presentation of current and past events, and a database containing measured pulses, derived locations, and user annotations. In prior systems, a continuous stream of audio data is sent over wired data connections from each sensor to a central computer where the data streams from multiple sensors are collected and analyzed. A continuous audio stream allows calculation of gunfire location from relative arrival times as well as allowing dispatchers to listen to a snippet of audio data and confirm that the impulses sound like gunfire. There are, however, several disadvantages of using wired connections, such as a telephone network, to communicate continuous streams of audio data from the sensors to the central computer. The most obvious disadvantage is that dedicated telephone lines are expensive to maintain and may not be readily available at the desired sensor locations.

### SUMMARY

Systems and methods consistent with the invention are directed to detecting and performing processing associated with noise and/or weapon fire incidents, such as those related to detecting or locating a weapon firing incident in a region. According to one or more embodiments, an exemplary method may include detecting acoustic signals from the region by one or more sensors, processing the detected acoustic signals to generate a processed signal, storing the detected acoustic signals with each sensor, and processing the processed signal associated with each sensor to determine if a weapon firing incident occurred. Moreover, exemplary methods may include, if unable to determine whether a weapon firing incident occurred, performing further processing of the acoustic signals and/or determining if a weapon firing incident occurred based upon the stored detected acoustic signals. Various other systems and methods are also disclosed.

It is to be understood that both the foregoing general description and the following detailed description are exemplary and explanatory only and are not restrictive of the invention, as described. Further features and/or variations may be provided in addition to those set forth herein. For example, the present invention may be directed to various combinations and subcombinations of the disclosed features and/or combinations and subcombinations of several further features disclosed below in the detailed description.

### DESCRIPTION OF THE DRAWINGS

The accompanying drawings, which constitute a part of this specification, illustrate various embodiments and aspects of the present invention and, together with the description, explain the principles of the invention. In the drawings:

FIG. 1A-1C are block and system diagrams of exemplary systems consistent with certain aspects related to the present invention;

FIGS. 2A-2D are diagrams illustrating exemplary systems, devices and data constructs consistent with certain aspects related to the present invention;

FIGS. 2E-2G are diagrams illustrating exemplary data and audio file features and/or processing consistent with certain aspects related to the present invention;

FIGS. 3A and 3B are flow charts illustrating exemplary weapon fire processing functionality consistent with certain aspects related to the present invention;

FIG. 4 is a flow chart illustrating further weapon fire processing consistent with certain aspects related to the present invention;

FIG. 5 is a flow chart illustrating exemplary noise incident processing consistent with certain aspects related to the present invention;

FIGS. 6A and 6B are diagrams illustrating exemplary detecting and transmitting features consistent with certain aspects related to the present invention;

FIG. 7 is a flow chart illustrating exemplary features of audio/data processing consistent with certain aspects of the present invention;

FIG. 8 is flow diagram illustrating exemplary features of audio/data processing consistent with certain aspects related to the present invention;

FIG. 9 is a flow diagram illustrating exemplary features of audio/data processing consistent with certain aspects of the present invention; and

FIG. 10 is a flow chart illustrating an exemplary methodology of noise event processing consistent with certain aspects related to the present invention.

### DETAILED DESCRIPTION

Reference will now be made in detail to the invention, examples of which are illustrated in the accompanying drawings. The implementations set forth in the following description do not represent all implementations consistent with the claimed invention. Instead, they are merely some examples consistent with certain aspects related to the invention. Wherever possible, the same reference numbers will be used throughout the drawings to refer to the same or like parts.

Various techniques may be used to detect, record and/or process signals obtained by sensors, for example, noise incidents such as weapon fire or gunshots received by acoustic sensors. Examples of such techniques are those that employ weapon fire detection and location processing as well as those that may include mobile sensing components and features.

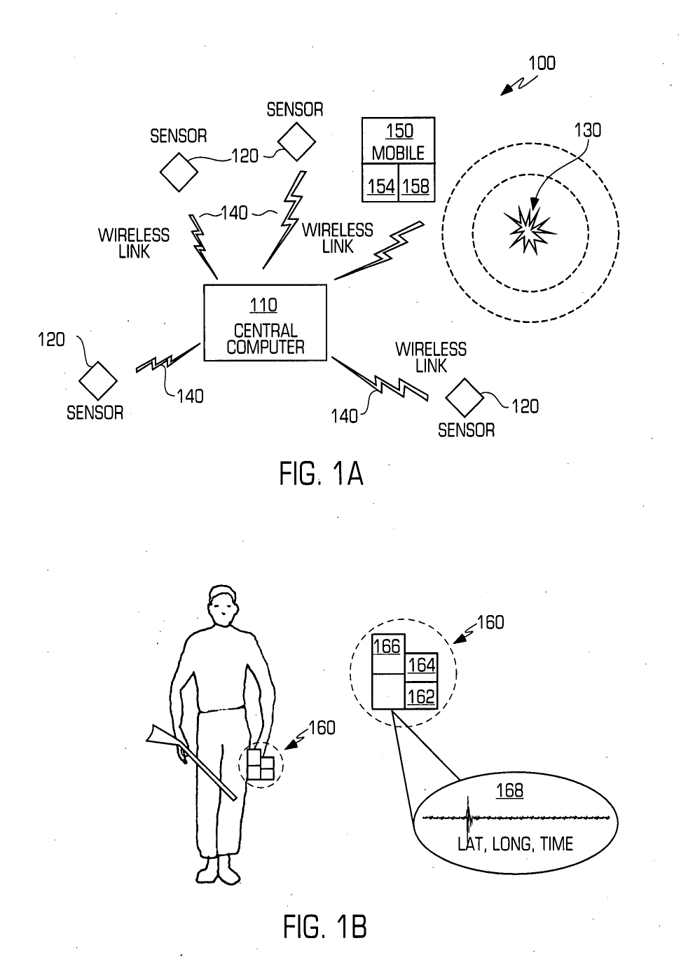

FIG. 1A is a block diagram illustrating features of an exemplary system consistent with aspects related to the present invention. Exemplary system 100 of FIG. 1A includes a central computer 110, sensors 120 that may have wired or wireless 140 links, an incident of weapon fire 130, as well as a mobile system 150 including a sensor. Further, with regard to mobile systems and sensors, the mobile system 150 may also include an associated processor 154 and an associated storage device 158, as well as additional attached components or subcomponents, as set forth throughout.

The fixed sensors 120 shown in FIG. 1A may be used, for example, in exemplary noise incident and/or gunshot location systems consistent with one or more aspects related to the present invention. According to these embodiments, semi-autonomous “smart” sensors may be connected via a data link to a central computer that includes a one or more wired or wireless links. Because a large number of sensors (perhaps several dozen) is typically used in a gunshot location system and because a continuous stream of audio data requires significant bandwidth, the present system uses a technique that reduces the bandwidth requirements. In particular, each sensor determines which pulses are likely gunshot events, determines the arrival time and other pulse characteristics of those pulses, and then sends these pulse characteristics to the central computer. Audio data clips for the pulses are stored at the sensor. The central computer then assembles the pulse characteristic data arriving from all the sensors and attempts to triangulate and confirm gunfire locations. In order to complete the process of obtaining data for user inspection, the central computer may send requests for audio data clips to those sensors which sent pulses contributing to a putative location. The sensors may respond by sending short segments of audio data (e.g., according to some exemplary aspects, between about 4 seconds and about 16 seconds, depending on the characteristics of the pulse) corresponding to the pulses. In this way, a manageable amount of data is requested and the communication link is not overloaded. Typically, in less than 30 seconds, the required data is available to a dispatcher for viewing and listening to assist in data qualification and in a decision to dispatch. Additionally the downloaded data may be used in re-processing the recorded audio to extract additional information or features from past audio data. Conversely, a suspected incident may trigger an event which causes the sensor to re-process the recorded data.

FIGS. 1B and 1C illustrate several exemplary implementations of mobile systems 150 consistent with certain aspects related to the present invention. According to a first example, FIG. 1B shows a user 145 carrying a mobile/portable system or device 160 that includes an acoustic sensor 162, a processing component 164, and an actuating component 166. Further, the device 160 obtains or is provided with timestamp and/or location stamp information 168. With these components, the device may be employed in various configurations to record audio signals and apply timestamps and/or location stamps to the audio data. According to one exemplary implementation, the device 160 may be set up so that it does not record audio until an instruction to do so is received from the actuating component 166. For example, the actuating component may be a button, switch, etc. on or in the device 160 that the user 145 activates in order to begin recording data, such as the recording of timestamped and/or location-stamped audio data. According to further aspects, recording may continue until a stop condition is reached. Some examples of such stop conditions include termination of a set period of time, triggering of the same or a different actuation component, upon receipt of instructions, such as a signal from a remote system or device via a communications network, etc. In other exemplary configurations, initial actuation may also be performed remotely, such that devices 160 either may or may not include internal actuation components.

According to a second example, FIG. 1C shows a user 145 carrying a mobile/portable system or device 160 that includes an acoustic sensor 162 and a receiving component 169, among other possible components such as a processing component, etc. According to one specific implementation, the receiving component may be a GPS receiver. As such, the device 160 may be used in connection with a GPS satellite network 170 to determine its location and the current time keyed, e.g., to a universal timebase. According to one exemplary implementation, here, the device 160 may be set up so that it does not initially record audio until one or more conditions are met. For example, audio recording may be turned on and recording of timestamped and location-stamped audio automatically initiated by the device 160 when it is brought into or near an area 180, a specified location 185, etc., such as within a given radius 182 of a particular location. As such, the device 160 may be configured to enable recording only when entering an active combat zone. Similarly, the device 160 could be configured to activate recording when a specific time in the future was reached. There may be one or more activation triggers known to the device, and these triggers may be added or removed by the user or by a message sent from a remote device via a communications network.

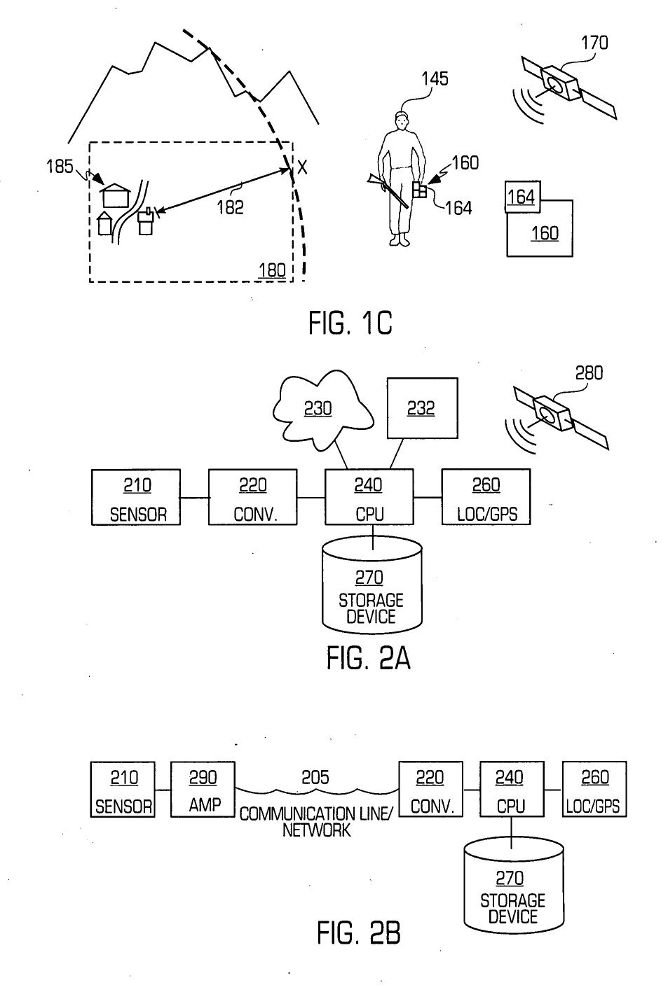

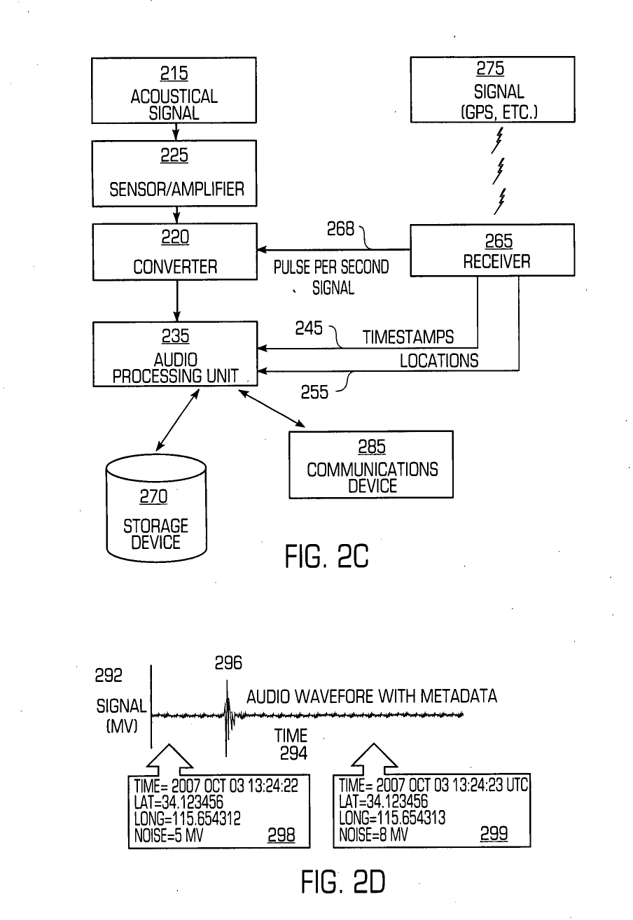

FIGS. 2A-2D are diagrams illustrating exemplary systems and devices consistent with certain aspects related to the present invention. FIG. 2A illustrates one exemplary implementation of an acoustic sensor device supporting recording of time- and location- stamped audio. A sensor 210, such as an acoustic transducer, converts sound pressure waves into a time-varying voltage level. A converter 220, such as an analog to digital converter (ADC), converts the time-varying voltage into a digital signal for further processing. The digital signal may then be supplied to a central processing unit 240. Location information is also supplied to the CPU 240 via a location-providing component 260. According to one specific example, a location or global positioning system (Loc./GPS) receiver 260 listens to signals from a network of GPS satellites 280 and converts them into a highly precise (<100 nanosecond) universal time reference and an estimate of the receiver's position, as latitude-longtitude in the WGS84 geographic coordinate system. The GPS receiver is connected to the CPU 240 with both a serial line and a digital signaling line. The digital signaling line, or the pulse per second line, is used by the CPU to drive the analog to digital converter's clock, ensuring that the recorded audio is precisely and accurately synchronized with a universal time reference such as Universal Time Coordinated (UTC). After digitization, the CPU 240 performs processing steps on the audio in order to evaluate the likelihood of acoustic signals of interest including but not limited to weapons discharges, improvised explosive device explosions, transformer explosions, vehicle sounds, helicopter sounds, or similar audio of a characteristic nature. The CPU may then store the audio, either before or after processing, to a fixed or removable storage device 270. The storage may be done continuously, only after detection of a sound of interest, or it may be done continuously with deletion automatically enabled for sounds not of interest. The acoustic sensor reports its status and the kinds of signals that it has detected to other sensors and/or computers via either a communications network 230, which may include one or more wired or wireless links, or a communication component 232 (e.g., RF transmitter, etc.). Some exemplary connectivity, here, may include acoustic modem over a telephone or analog radio; an Ethernet network; an 802.11b network; a radio network, such as a proprietary radio network in the 800 MHz, 900 MHz, 2.4 GHz, or 4.8 GHz bands, etc.

FIG. 2B shows another exemplary implementation of an acoustic sensor supporting recording of time- and location-stamped audio. In this example, a sensor 210 and amplifier 290 are located a distance (any distance, including typically 500 ft to 10 miles) from the central processing unit 240. The amplified analog signal may be delivered via a communications line or network 205 to a central computer. Suitable communications networks for this purpose include physical direct wiring, the public switched telephone network, amplitude-modulated radio, or frequency-modulated radio. At the central processing unit, the analog signal may be converted to a digital signal using a converter 220 such as an analog to digital converter. Conversion to a digital signal may also be performed at any point in this process, from the sensor throughout the end processing component, entailing differing placement of such components or rendering them obsolete. A location-providing component 260, such as a GPS receiver, may also be associated with or within the central processing unit. In one exemplary embodiment, the converter 220 may either be driven by an external clock driven by the GPS pulse per second line, or have hardware triggers that capture of the value of the sample clock counter each time a GPS pulse-per-second signal is detected. In such embodiments, one or more analog sensors may be handled by each central processing unit. Only one GPS receiver is required for each set of sensors; the speed of light is such that it can be assumed that the transmission time across the line/network is negligible. The GPS receiver can no longer be used to determine the location of each sensor, but if the sensors are restricted to permanent deployments in known locations, then their position can be determined by survey and that position stored in the storage device 270 for later use. In the illustrated and discussed example, the digitized audio stream may be time-synchronized with a universal time reference using the GPS receiver and location-stamped using a look-up table of surveyed sensor positions. The CPU 240 stores the audio, either before or after processing, to a fixed or removable storage device 270. The storage may be done continuously, only after detection of a sound of interest, or it may be done continuously with deletion automatically enabled for sounds not of interest.

FIG. 2C is a diagrammatical representation related to the system of FIG. 1A, showing aspects and further processing features thereof. In the illustrative diagram of FIG. 2C, acoustic signals 215 may be converted from a time-varying pressure to a time-varying signal/voltage by a sensor/amplifier component 225 (e.g., a microphone or acoustic sensor and amplifier) which may then be converted by a converter (i.e., digitized by an analog to digital converter). In the exemplary embodiment shown, a pulse per second line 268 from a receiver 265 is used to synthesize an accurate 44100 cycles per second clock that starts concurrently with the one pulse per second signal from the receiver. This signal is derived from signals sent from a signal source 275, such as a GPS satellite network. While the pulse per second line drives the sampling rate to a precise number of samples per second, the receiver communicates with an audio processing unit 235 via another data communication channel, such as a serial port. Timing 245 and location 255 information may be sent to the audio processing port in such a manner that a timestamp may be unambiguously associated with a specific pulse per second signal on the pulse per second line. The timing and location information may be sent in a variety of suitable formats, such as text format or binary (machine) format. The simultaneous acquisition of audio data, timestamp data, and location stamp data by the audio processing unit allows the unit to write the incoming audio stream to a storage device 270 as a series of files or records, each of which contains a record of the timestamp applicable to the first sample of audio in the file or record, and a location stamp associated with the entire file or record. New time and location stamps should be used as quickly as they are available from the receiver 265 in order to fully utilize the capabilities of the receiver; for example, should the receiver computer a new location estimate each second, the timestamp and location stamp should be written to the storage device each second. This feature is particularly advantageous in the systems set forth herein that include a distributed network of acoustic sensors that make use of the disclosed timestamping features. FIG. 2D illustrates an exemplary audio file consistent with certain aspects related to the present invention. Sound is manifested at a point in space as a time-varying pressure. A microphone converts the pressure into a signal or voltage 292 for each sample of time 294. The signal or voltage can be converted to a digital signal using an analog-to-digital converter (ADC) for processing or storage on a to digital computer. According to one or more aspects of the invention, a pulse per second line from a GPS receiver is used to drive the sample rate and starting offset of the ADC, with the result that every second the audio stream is resynchronized with a precise and accurate timestamp from the GPS system. The GPS receiver may also provide an estimate of the location of the receiver at specified times, such as once per second. The simultaneous sampling of audio and GPS data allows for the generation of timestamped and location-stamped segments of digital audio. These simultaneous measurements allow an acoustic recording of a gunshot signal 296 to be used in numerical algorithms that determine the location of a weapon discharge based on the arrival time measurement and location of several sensors.

FIGS. 2E-2G are diagrams illustrating exemplary data and audio file features and/or processing consistent with certain aspects related to the present invention. FIG. 2E illustrates an exemplary method for encoding timestamps and location stamps in a binary file format. Binary formats are compact but more difficult to extend to support additional metadata. In this examplary format, timestamp and location stamp metadata are stored. The integer values such as sampling rate and number of channels may be stored as big- or little-endian 32 bit long integers, while the timestamps, latitude and longitude may be stored as 64 bit IEEE double-precision floating point numbers. The timestamp refers to the number of seconds that have elapsed since the beginning of the GPS Epoch (0 hour UTC on Jan. 6, 1980). Latitude and Longitude are in the WGS84 geographic coordinate system. In one exemplary implementation advantageously employed with the systems herein, the first sample in each file begins on precisely on a second boundary, synchronized with the pulse per second signal obtained from the GPS receiver.

FIG. 2F illustrates an exemplary method for encoding timestamps, location stamps, and other arbitrary metadata in an audio file format consistent with certain aspects related to the present invention. The WAVE file format is a container format that supports the addition of arbitrary chunks of user data in addition to the required “fmt ” and “data” chunks. In this exemplary feature, a metadata chunk “ssmd” is also embedded in the WAVE file. This metadata can be stored in a binary or text representation such as line-ending delimited, comma delimited, or XML preferably a text representation to facilitate the addition of new metadata fields. In one exemplary implementation advantageously employed with the systems herein, the first sample in each WAVE file begins on precisely on a second boundary, synchronized with the pulse per second signal obtained from the GPS receiver.

FIG. 2G illustrates one format of the “ssmd” metadata chunk feature consistent with certain aspects related to the present invention. In this exemplary implementation, the location and timestamps are stored as line-ending delimited UTF-8 encoded text. The values should be written out to a precision that exceeds that of the measuring device so that precision is not lost due to rounding. Additional metadata fields may be added without rendering existing files unreadable.

With regard to metadata, numerous important aspects of the innovations herein relate to association of precise and accurate timestamps and location stamps with the sampled acoustic data. Timestamps, here, may be obtained or derived from a time reference source such as the Global Positioning System receiver, a high-precision (“atomic”) clock, or from network time synchronization. Further, the audio and time source data may be sampled together in order to provide precise timing of the audio. In one exemplary implementation, the pulse per second digital line from the Global Positioning System receiver chip is used as a reference to drive the ADC sample clock to an integer number of ADC samples per pulse per second signals, preferably at a standard sampling rate for audio such as 44100 samples per second. The actual time associated with each pulse per second pulse may be read from the GPS device or other precision time source. In another exemplary implementation, the ADC clock may run independently and a hardware trigger may read the sample counter each time a pulse per second signal appears. Here, the precise timing of each sample may be obtained by interpolation of the sample counters associated with each timestamp.

According to further features, here, the incoming audio stream may be to divided into distinct segments of finite length in order to facilitate storage and management of the audio data. In order to allow reassembly of the audio stream in correct time order, each segment of audio may be stored with a precise and accurate timestamp that represents time at the start of the first sample in a universal time reference, and each audio segment ends exactly one sample before the start of the next segment. The sample size is kept small enough that there is negligible drift in the sample clock in between segments. One exemplary embodiment sets the sample clock at an integer number of samples per second (because the commonly-used WAVE file format does not support non-integer sampling rates) and divides the audio into segments between 0.01 and 3600 seconds in length, e.g., one second in length. Such length facilitates resynchronization on each pulse per second signal and provides adequate granularity for the selective storage, retention, or transmission of audio excerpts of a length appropriate for a weapons detection system, which is typically between 1 second and 15 seconds.

In addition to the timestamp metadata, the sensor location may also be stored with the audio data, consistent with certain implementations herein. For example, sensor location may be obtained from a GPS receiver and stored using latitude and longitude in the WGS84 geographic coordinate system. Other metadata, such as the local temperature, the gain on a microphone, background noise level, etc., can also be stored as metadata with the time-synchronized audio. In one exemplary embodiment, the metadata is stored within a standard WAVE file by appending a custom data chunk containing the timestamp, location, and other metadata. In another exemplary embodiment, a separate metadata text file is stored along with each WAVE file. The WAVE files may be stored in a structure that allows rapid search and retrieval of time segments of interest, such as a tree data structure organized by time or a hash table. In yet another exemplary embodiment, the data may be stored in a non-standard format and WAVE file generation happens during the retrieval and transfer process.

According to aspects of the innovations herein where each discrete audio segment is timestamped, continuous recording is not required in order to have a precise and accurate time of each sample. Examples of when the discontinuous (selective) recording ability of the invention are particularly useful include making more efficient use of storage space by not storing data when there is no signal of interest to record, complying with legal requirements pertaining to the recording of speech, among others.

According to one or more further aspects of the innovations herein, recording may be disabled by default and enabled only when certain conditions (such as detection of a weapon event by an audio processing algorithm on the sensor, detection of a specific vehicle by an audio processing algorithm on the sensor, a signal from a remote device or a signal from a person, etc.) are met. According to other aspects, recording to the storage device may be set as always enabled, while each audio segment is marked for deletion at a specified point in the near future, such as about ten seconds to about one minute in the future. In this embodiment, the audio is automatically deleted unless the sensor removes the deletion mark, which it may do when certain conditions (such as detection of a weapon event by an audio processing algorithm on the sensor, detection of a specific vehicle by an audio processing algorithm on the sensor, a signal from a remote device, or a signal from a person) are met. Such exemplary store-and-delete processes impart notable advantages because they enable recovery of audio that is earlier in time than the first sample flagged as of interest by the sensor's audio processing algorithms. This extra audio data is particularly useful in many of the present weapons detection systems. For example, when a given sensor hears a gun discharge and reports that discharge to a remote processing unit, but does not receive a request to retain the audio until the incident has been confirmed by several other sensors some time (a few seconds) later. For such applications, selective retention is superior to selective recording.

According to other aspects of the invention, time- and location-stamped audio may be selectively downloaded to other sensors or computers for further analysis or review via a wireless or wired communication network. The audio may be stored on the device continuously or discontinuously. Such remote requests for audio may be made in terms of a request starting at a certain time for a certain duration. After receiving the request, the sensor may search its storage devices for audio that lies within the requested range and then return that audio. Alternately, if all of the requested data is not available, a subset of the requested audio may be returned. According to one or more related aspects of the invention, then, the transmission protocols employed include methods to transfer the associated timestamps along with the audio files, so that precise and accurate timestamps for each sample are obtained even when the request is only partially filled by the sensor.

Aspects of the wireless features and functionality herein provide even further advantage, such as sampling of audio data at a higher rate than possible with existing telephony and network connections, as well as obtaining greater fidelity that assists in more accurate event classification.

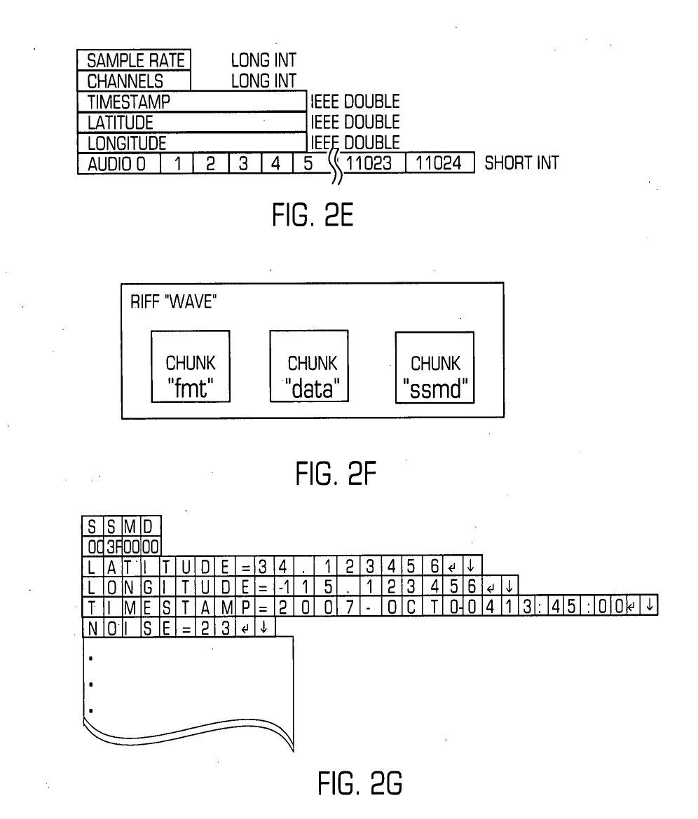

FIG. 3A is a flow chart illustrating exemplary weapon fire processing functionality consistent with certain aspects related to the present invention. Flow diagram 300 of FIG. 3 is directed to detection and processing associated with potential weapon fire situations, such as those related to locating a weapon firing incident. According to one or more embodiments, an exemplary method 300 may include detecting acoustic signals from the region by one or more sensors 310, processing the detected acoustic signals to generating a processed signal 320, storing the detected acoustic signals with each sensor 330, and processing the processed signal associated with each sensor to determine if a weapon firing incident occurred 340. Moreover, such exemplary method 300 may also include additional processing based upon a step of determining whether the system is able to determine if a weapon firing incident occurred 350. For example, if the system or processors associated therewith are able to determine that a weapon firing incident occurred based on the stored detected signals 354, the system may then continue to analyze or process this data under any weapon fire incident processing 360 employed by the system that is appropriate to the detected type of weapon fire. If the system or related processor is unable to determine whether or not a weapon fire incident occurred based on processing of the stored data at the sensor, then further processing of the acoustic signals, including further determination as to whether a weapon firing incident occurred, may be performed 368. A variety of such further processing steps may be employed, such as set forth below. For example, a processor may perform further processing of the stored acoustic signal to determine if a weapon firing incident occurred, and, if unable to determine if a weapon firing incident occurred based on that analysis, determining if a weapon firing event occurred based upon the stored detected acoustic signals. Here, if the system/processors are able to determine that a weapon firing incident occurred based upon such further processing, the system may then continue to analyze or process this data under any weapon fire incident processing 360 employed by the system that is appropriate to the detected type of weapon fire.

FIG. 3B is another exemplary flow chart illustrating further detail of the processing/determining step 368 of FIG. 3A. Specifically, if the system or related processor is unable to determine whether or not a weapon fire incident occurred based on processing of the stored data at the sensor, then further processing of the stored detected acoustic signals may be performed 370. For example, the sensor data may be acquired and analyzed by another processor or computer, at another location, etc. With regard to the data stored at the sensor being acquired, analyzed, etc. in such further manner, a step of determining if a weapon firing incident occurred based upon the stored detected acoustic signals 380 may then also be performed. Here, if the system/processors are able to determine that a weapon firing incident occurred based upon such additional processing 384, the system may then continue to analyze or process this data under any weapon fire incident processing 360 employed by the system that is appropriate to the detected type of weapon fire. If it is determined that no weapon fire incident occurred 388, then the system/processor may continue with basic processing of remaining data 390.

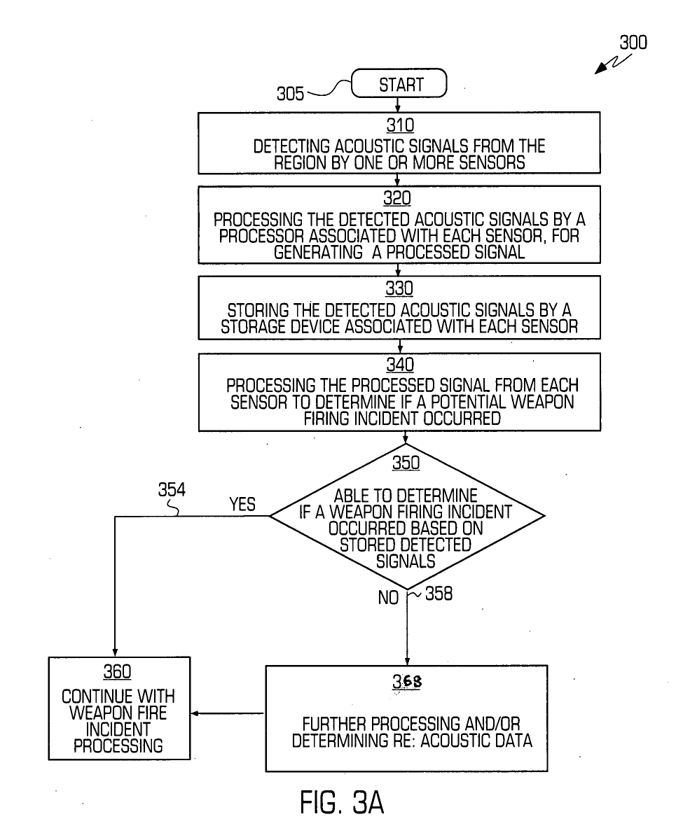

FIG. 4 is a flow chart illustrating further weapon fire processing features consistent with certain further aspects related to the present invention. Exemplary process 400 of FIG. 4 includes the steps of FIG. 3A or 3B, with elaboration of the performing further processing functionality. The new steps of FIG. 4, steps 410 and 420, describe exemplary requesting and communicating of information steps, such as may be performed between an external processing component and fixed sensors. For example, wireless communication between a central gunshot location processing computer and fixed sensors in an area of interest. As shown in FIG. 4, the step of performing further processing may include requesting stored acoustic signals from one or more sensors 410, and communicating the stored detected acoustic signals in response thereto 420. Again, such request and communication may be performed for the purpose of providing further or more detailed analysis on the sensor data in question. Further, requests for audio clips may in some cases be sent to all of the sensors within a predetermined distance of a putative location, say 2 miles. Using the returned audio clips, a human operator may also be employed to potentially determine a pulse detection which the pulse detector on the sensor might not have been able to automatically recognize. Following such further processing, the analyzing computer/processor may proceed to weapon fire incident processing 360 or basic processing 390 as shown in FIG. 4 (and described in more detail above), according to the results of this subsequent analysis.

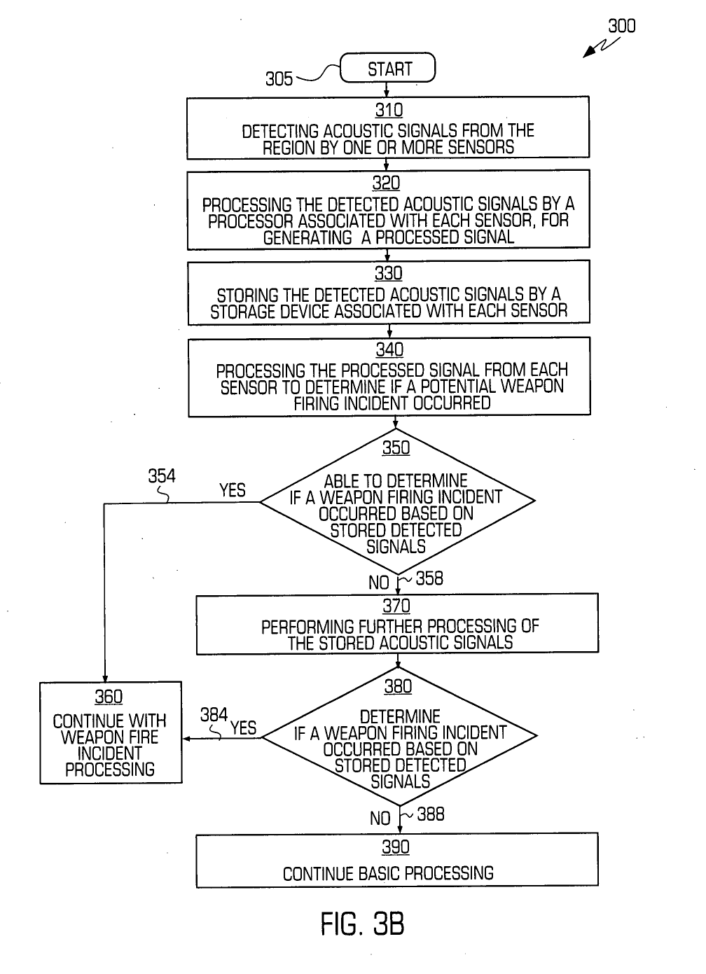

FIG. 5 is a flow chart illustrating exemplary noise incident processing consistent with certain aspects related to the present invention. According to these aspects of the innovations herein, exemplary method 500 may include detecting acoustic signals from the region by one or more sensors 510, processing the detected acoustic signals to generating a processed signal 520, storing the detected acoustic signals with each sensor 530, and processing the processed signal associated with each sensor to determine if a noise incident occurred 540. Moreover, such exemplary method 300 may also include additional processing based upon a step of determining whether the system is able to determine if a noise incident occurred 550. For example, if the system or processors associated therewith are able to determine that a noise incident occurred based on the stored detected signals 554, the system may then continue to analyze or process this data under any noise incident processing 560 employed by the system that is appropriate to the detected type of noise. If the system or related processor is unable to determine whether or not a noise incident occurred, then further processing of the acoustic signals may be performed. For example, further processing may include requesting stored acoustic signals from one or more sensors 570, and communicating the stored detected acoustic signals in response thereto 572. Finally, steps of determining 580 and continue 590 processing, consistent with those described above, may then also be performed.

With regard to request and communication of data, various implementations of exemplary transmissions including exemplary wireless transmissions are described below. For example, the protocols used to facilitate downloading of the spool data may take into account the uncertain nature and limited bandwidth of the communication link. The system may also be configured such that the central computer should not need to know the details of the storage implementation. Further, the data may be requested based on double precision GPS time which gives plenty of precision even for 192 kHz sampling. Negative time that indicates seconds before the request was received may also be employed to allow for relative timing instead of fixed timing.

Moreover, each request may be configured to include start time, length, sample rate, number of channels, requested compression and associated flag information. The sensor will service the request the best that it is able (i.e. if the spool is single channel, it cannot provide multiple channels of data). Data can be re-requested or re-sent in case the communications link lost data.

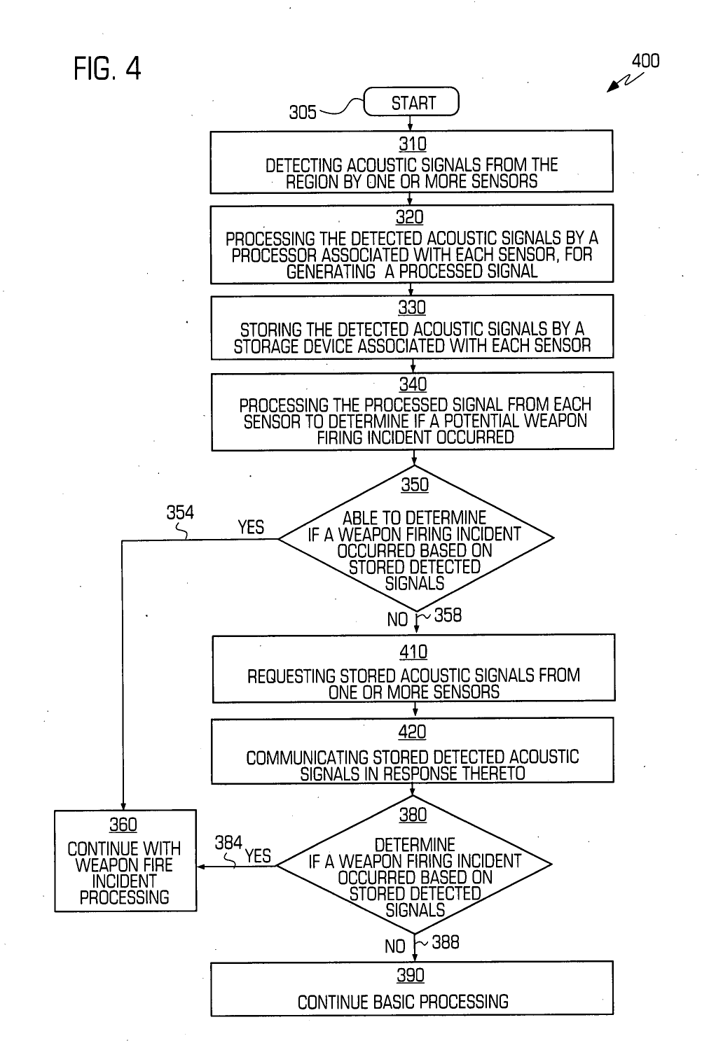

FIGS. 6A and 6B are diagrams illustrating exemplary detecting and transmitting features consistent with certain aspects related to the present invention. FIG. 6A outlines some further exemplary processing steps consistent with the invention, related to detecting weapon events or characteristic noises of items of interest such as vehicles. According to this example, a signal obtained from a sensor may first be converted 610, i.e., an amplified acoustic signal obtained from a microphone may be digitized by an analog to digital converter, which allows further processing to be performed digitally. The digital audio signal may then be filtered digitally 620 using, for example, finite impulse response (FIR) and/or infinite impulse response (IIR) digital filters in order to increase the signal to noise ratio for signals of interest. The filtered signal may then be processed by an impulse detection routine 630 which may comprises one or more techniques such as: searching for signal where the slope of the signal-vs-time plot exceeds a certain threshold; searching for signals where the increase in power from background noise exceeds a certain threshold; searching for signals that match a desired time-domain envelope to within a certain tolerance. After an impulse has been detected and its onset time precisely determined, further processing steps 640 are taken to characterize the impulse so detected. Many signal processing steps are appropriate for characterizing an impulsive signal, including techniques such as: taking the Fourier transform of the acoustic signal in order to determine its frequency components; taking the Hilbert transform of the acoustic signal in order to determine the low-frequency envelope of the impulse; taking the wavelet transform of the acoustic signal in order to determine the joint time- and frequency-distribution of the signal power. These characteristics of the impulse can be used by later processing steps to identify possible sources of the impulsive sound.

FIG. 6B outlines one exemplary protocol for sending time and location stamped audio via a communications link. In the example, a base station 660 initiates a request 632 for audio derived from a sensor 650 by requesting a specific duration of time beginning at a specific starting point. Here, both the sensor 650 and the remote unit must use a common time base and format. An exemplary timebase would be the UTC timebase and an exemplary format the number of double-precision floating point seconds since the beginning of the GPS epoch. The sensor 650 responds using a protocol 634 that self-describes the time of the start of the first sample it sends back along with location stamps and any other required metadata. Note that, in aspects consistent with this example, the sensor need not be able to fulfill the entire request for the protocol to deliver time- and location-stamped audio back to the base station; so long as there is some overlap between the stored audio available on the sensor and the time range requested by the base station, the sensor will return some audio and that audio will be appropriately time- and location-stamped to universal time and location references.

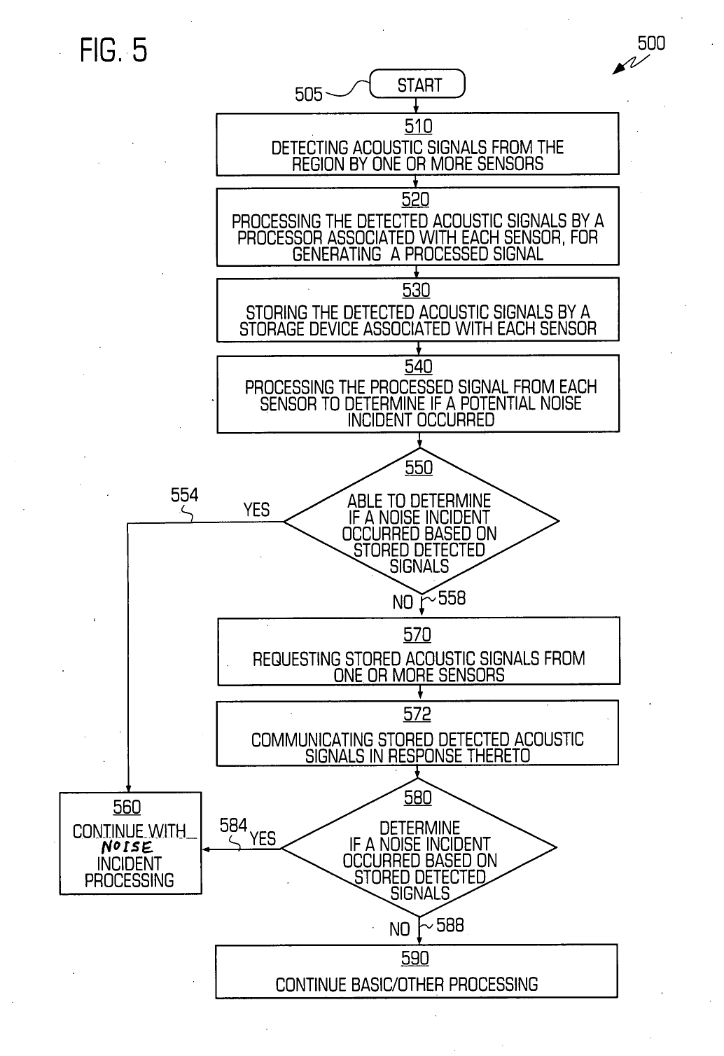

FIG. 7 is a flow chart illustrating exemplary features of audio/data processing consistent with certain aspects of the present invention. Exemplary flow diagram 700 of FIG. 7 shows functionality according to aspects of the invention where audio information is recorded selectively if and only if the processing of the acoustic data warrants the data to be stored. According to this example, input audio from other stages is processed by an audio processing step 710. If the audio processing indicates affirmative 728 to a possible weapon event 720, the processor sends a request to the audio output stage 730 to assemble a subset of the audio data along with a precise and accurate timestamp describing the time of the first sample in a universal time reference, and a location stamp in the form of WGS84 latitude-longitude or other appropriate coordinate system. The resulting data may be sent along or recorded in a non-volatile fashion, for example, using the storage device 740. In another embodiment, the audio data is stored in volatile memory for a short period of time, such as 10 seconds to 120 seconds, so as to allow the audio processing step time to evaluate the audio stream for the presence of weapon discharge events, or other events that the audio processing algorithms have been directed to record such as a vehicle, helicopter, other proscribed noise incident, etc.

In addition to such storage devices 740, sensors may also be provided with firmware as well as with one or more central computer software functions via installed software. Furthermore, in one exemplary implementation, sensors may be provided with two secure digital (SD) memory cards, each with 2-GB or greater capacity. The cards may be used to spool accumulated audio data. Further, any standard memory storage mechanism will work. On the sensor, data reads and writes may be started with direct call but, according to some exemplary aspects, the routine to access the SD has a state machine that communicates with the SD cards via a serial peripheral interface (SPI). Through down-sampling and compression (e.g., ulaw), the present systems and methods may achieve greater than 100 hours of continuous recording capacity. Inclusion of any variety of removable storage media enables bulk retrieval for data stored on removable media. As such, all of the data stored on the media may be acquired when removed and read with the appropriate application.

Moreover, as stored on the storage devices or prepared for the act of data transfer, the data can be compressed to permit quicker downloads or longer spooling. Preferably, the recorded data us lossily- or losslessly compressed digital representations of audio including but not limited to: p-Law companding in the style of ITU-T G.711; ADPCM; lossless systems that use a variable-bit-width encoding so that periods of quiet audio may be transferred with fewer bits.

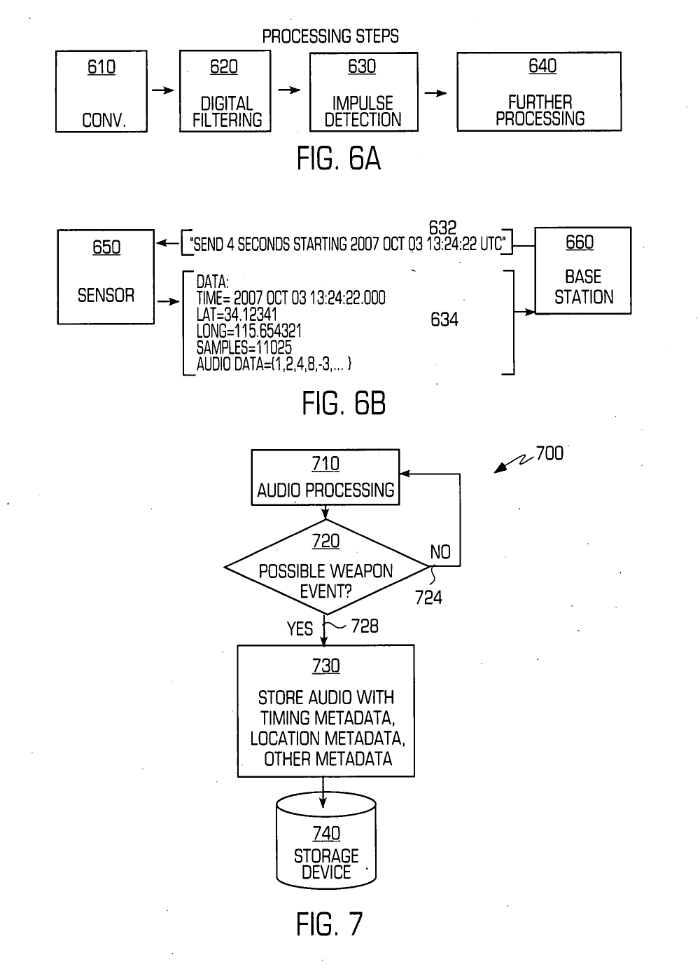

FIG. 8 is flow diagram illustrating exemplary features of audio/data processing consistent with certain aspects related to the present invention. Flow diagram 800 shows another exemplary embodiment of selective recording aspects related to the present invention. An audio processing stage 710 may analyze the incoming audio stream for weapon discharge events or other events of interest. Here, in contrast to FIG. 7, an audio output stage 730 may assemble continuous subsets of the audio data along with precise and accurate timestamps and location stamps and write them to a storage device 740, such as a non-volatile storage device. Further, the output stage 730 may mark each subset written as acceptable for later deletion. Should the audio processing stage 710 detect a weapon discharge sound or other incident of interest 720, a decision is made 818 to remove the mark allowing the audio to be deleted in the future, such as via an automated timed delete process 830. This embodiment allows the length of time between the recording of the audio and the point at which it is automatically deleted to be as large as the size of the storage device, which is typically much larger than the amount of non-volatile memory available at the audio processing stage.

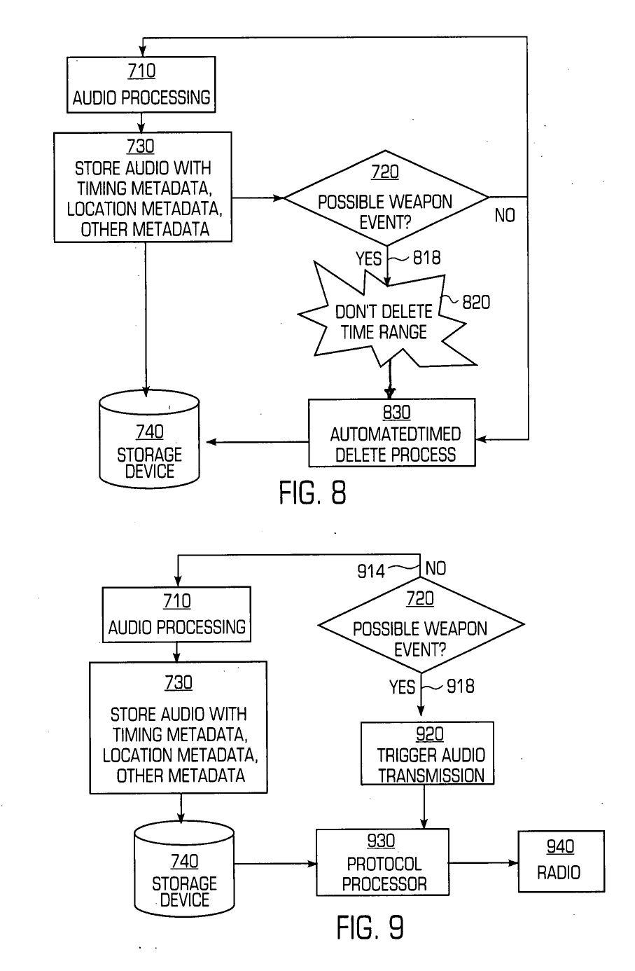

FIG. 9 is a flow diagram illustrating exemplary features of audio/data processing consistent with certain aspects of the present invention. In the exemplary flow diagram 900 of FIG. 9, the audio processor 710 passes acoustic data to the audio output stage 730, which assembles continuous subsets of the audio data along with precise and accurate timestamps and location stamps and may send them or write them to a storage device 740, such as a non-volatile storage device. Based on processing of the acoustic data, the audio processing stage 710 can determine whether or not a possible weapon event has occurred 720. If no weapon event is detected 914, no automatic download is triggered and other audio processing may continue. If a possible weapon event is detected 918, a message may be sent 920 to the protocol processor 930 to encapsulate a subset (typically 2 to 20 seconds) of the audio in question with precise data and/or metadata. For example, precise and accurate timestamps of the first sample in the transmitted audio and location stamps that describe the position of the sensor over the time period of the audio recording. Finally, the combined audio data and metadata may be delivered 940 for subsequent processing, e.g., transmitted to a remote computation device using radio or other communications device. In other exemplary aspects, the encapsulation and transmission of audio data and metadata is triggered by a signal from a remote device that is received via a communications device 940, such as a bi-directional transceiver. These aspect have particular utility herein, as the remote processing unit can utilize audio measurements from all sensors on a sensor network and request audio based on the predicted arrival time at each sensor, this embodiment allows the downloading of weapon discharge audio from a sensor on which the signal-to-noise ratio of the weapon discharge signal was too low to allow for accurate on-board detection of the weapon discharge incident.

Turning back to features of the sensors, the various sensor devices herein, again, can also record a variety of data in addition to or instead of the audio data. As set forth above, such sensors can record metadata about the conditions under which the data was recorded, including the physical position of the sensor, generally a record of latitude and longitude at short (<10 s) intervals. For fixed sensors, this allows a higher accuracy GPS position to be determined. For portable sensors, this enables tracking of the sensor movement. The sensor devices can also record the outputs of non-audio sensors, including those for sensing weather conditions and nuclear, chemical, or biological hazards. The sensor may record information about the its state while it was processing the audio, including intermediate results of sensor computations including status or debugging information, frequency-domain summaries, angle-of-arrival calculations, etc.

Additional measurement information may also be added to the spool and downloaded to allow other data, including non-audio data, to be tracked and reported. This information includes but is not limited to: 1) Calibration data like the general level of audio noise through a multi-day period. 2) User-supplied data (especially for a person-worn or vehicle-mounted sensor), including audio annotations describing events, either from the GLS microphones or from a separate microphone, and a simple lime-of-interest' logger where a user indicates that a particular time may be useful to revisit, perhaps because there are audio annotations at that time or because an interesting event occurred at the time. 3) Data for system debugging, such as the internal state of the signal processing algorithms, raw data received from peripheral systems, monitoring physical location of the sensor over time, total pulse information over an extended time period. This data can be either asynchronous or synchronized with the audio stream.

The sensor may also record external indications of times of interest in order to make it easier for users of the sensor's information (processing components, etc.) to sort through the data they can retrieve from the sensor. Other known actuation mechanisms or indicators, beyond the button and switch features discussed above, allow a person to identify that information recorded by the sensor near the indicated time is likely to be of interest later.

Audio may be stored in the sensors for many hours or longer, and may include audio downloaded in short bursts when impulses or other noise incidents of interest are identified. This can allow additional data to be obtained from the sensors if, for example, a pulse corresponding to gunshot is identified/located. A flag may be added to the data to allow it to be downloaded at a later time when the communication link allows for higher bandwidth or longer downloads.

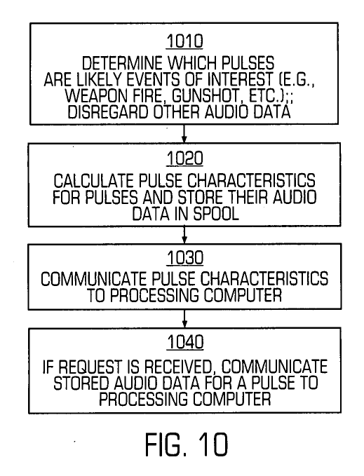

FIG. 10 is a flow chart illustrating an exemplary methodology of noise event and/or pulse processing consistent with certain aspects related to the present invention. In an initial step 1010, a processor associated with a sensor or other distributed processing component may determine which blocks of data, noise incidents, pulses, etc. are likely events of interest, and disregard other audio data. Then this processor/processing component can calculate pulse characteristics for audio pulses and store their audio data in a spool 1020. Next, this processor/processing component may communicate the calculated pulse characteristics to another (e.g., base, central, etc.) processing computer, which may perform more detailed or exhaustive processing on the pulse data. If further analysis is then determined to be required, a request is sent for supplemental transfer of some or all of the related data, such as the raw data. When the request is received, the initial processor/processing component then communicates the stored audio data related to the pulse to the second computer.

The audio data processing set forth above allows system detection parameters to be more easily tuned to balance false alarms vs. sensitivity to substantive incidents. Further, these data processing features permit improved functionality such as parallel/additional/multiple pulse analysis on the central computer which is often not readily implemented on the sensor, with its more limited resources. Moreover, power management of the sensor is more effective when lesser quantities of data need to be transmitted, as the communication link and communicating elements are generally the main consumers of power in such sensor devices.

As disclosed herein, embodiments and features of the invention may be implemented through computer-hardware, software and/or firmware. For example, the systems and methods disclosed herein may be embodied in various forms including, for example, a data processor, such as a computer that also includes a database, digital electronic circuitry, firmware, software, or in combinations of them. Further, while some of the disclosed implementations describe source code editing components such as software, systems and methods consistent with the present invention may be implemented with any combination of hardware, software and/or firmware. Moreover, the above-noted features and other aspects and principles of the present invention may be implemented in various environments. Such environments and related applications may be specially constructed for performing the various processes and operations according to the invention or they may include a general-purpose computer or computing platform selectively activated or reconfigured by code to provide the necessary functionality. The processes disclosed herein are not inherently related to any particular computer, network, architecture, environment, or other apparatus, and may be implemented by a suitable combination of hardware, software, and/or firmware. For example, various general-purpose machines may be used with programs written in accordance with teachings of the invention, or it may be more convenient to construct a specialized apparatus or system to perform the required methods and techniques.

The systems and methods disclosed herein may be implemented as a computer program product, i.e., a computer program tangibly embodied in an information carrier, e.g., in a machine readable storage medium or element or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand alone program or as a module, component, subroutine, or other unit suitable for use in a computing environment. A computer program can be deployed to be executed on one computer or on multiple computers at one site or distributed across multiple sites and interconnected by a communication network.

It is to be understood that the foregoing description is intended to illustrate and not to limit the scope of the invention, which is defined by the scope of the appended claims. Other embodiments are within the scope of the following claims.

1. A method of detecting a weapon firing incident in a region, wherein said weapon firing incident characterized by a particular acoustic signal, said method comprising:
detecting acoustic signals from the region by one or more sensors;
processing the detected acoustic signals by a first processor associated with each sensor, for generating a processed signal;
storing the detected acoustic signals by a storage device associated with each sensor;
processing the processed signal associated with each sensor to determine if a potential weapon firing incident occurred, and if unable to determine whether a weapon firing incident occurred:
transferring data including metadata about the detected acoustic signals to a second processor, the metadata including frequency domain information and/or angle of arrival information;
performing further processing of the stored acoustic signals including determining if a weapon firing incident occurred.

2. The method of claim 1 wherein the step of performing further processing includes:
requesting the stored acoustic signals from the storage device associated with each sensor; and
communication the stored detected acoustic signals to a second processor in response thereto.

3. A method of detecting an incident in a region and creating an audio record related thereto, said method comprising:
detecting acoustic signals from the region by one or more sensors;
processing the detected acoustic signals by a first processor associated with each sensor, for generating a processed signal;
storing the detected acoustic signals by a storage device associated with each sensor;
processing the processed signal associated with each sensor to determine if a noise incident occurred, wherein the noise incident is characterized by a particular acoustic signal, and if unable to make such determination:
transferring data including metadata about the detected acoustic signals to a second processor, the metadata including frequency domain information and/or angle of arrival information;
performing further processing on the stored acoustic signals from the storage device associated with each sensor;
determining, at the second processor, if an incident occurred based upon the stored detected acoustic signals; and
creating an audio record associated with the incident.

4. The method of claim 1 or claim 3 further comprising storing the detected acoustic signals in the storage devices selectively.

5. The method of claim 1 or claim 3 further comprising retrieving a subset of the data from the storage devices using wired or wireless sensors.

6. The method of claim 1 or claim 3 further comprising recording data to fixed or removable media devices at the remote sensor including one or more features of using compressed or uncompressed format, storing audio at an original sampling rate or resampled at a different sampling rate, and/or having encrypted or unencrypted format.

7. The method of claim 1 or claim 3 further comprising transferring recorded data using a protocol that allows the server to request time-specified data segments by using: (i) high-resolution time stamps, accurate to less than a sample time on the remote device, (ii) low-resolution time stamps, where the extra complexity required by a protocol for high-resolution time stamps does not warrant the savings in bandwidth; and/or (iii) with timestamps that are interpreted relative to the current or a flagged time on the sensor.

8. The method of claim 1 or claim 3 further comprising transferring recorded data using a protocol that allows the server to request data segments as a function of metadata.

9. The method of claim 1 or claim 3 further comprising recording audio or measurement data and associated metadata using a circular buffer to maximize spooling for the most recent span of time.

10. The method of claim 1 or claim 3 further comprising labeling stored data as being of potential interest.

11. The method of claim 10 wherein the labeling of data is performed by algorithms running on the sensor, including algorithms that attempt to detect impulsive noises, including gunshots, firecrackers, and/or explosions.

12. The method of claim 3 further comprising labeling stored data as being of potential interest, wherein the labeling of data is performed by algorithms running on the sensor, including algorithms that attempt to detect signatures of vehicles.

13. The method of claim 3 further comprising labeling stored data as being of potential interest, wherein the labeling of data is performed by algorithms running on the sensor that detect when the sensor is near one or more specified times or places.

14. The method of claim 1 or claim 3 further comprising storing a subset of data flagged to be of interest.

15. The method of claim 1 or claim 3 further comprising storing a subset of data flagged to be of interest either for a period of time longer than data not so tagged, or indefinitely.

16. The method of claim 1 or claim 3 further comprising retrieving a subset of data flagged to be of interest.

17. The method of claim 1 or claim 3 further comprising automatically triggering the retrieval of data flagged to be of interest.

18. The method of claim 1 or claim 3 further comprising deleting data not flagged to be of interest, wherein all gunshot/noise detection processing is performed on the audio data within 30 seconds and any audio data not identified as being of interest after that time is deleted.

19. The method of claim 1 or claim 3 further comprising retrieving a subset of metadata about data identified as being of interest, wherein the metadata is associated with one or both of a time-mark of interest and/or a location.

20. The method of claim 1 or claim 3 further comprising recording audio data and transferring information including the audio data and second metadata about conditions under which the data was recorded.

21. The method of claim 20 wherein the second metadata includes information about a time associated with the recorded data.

22. The method of claim 21 wherein the time is synchronized to a common time base.

23. The method of claim 20 wherein the second metadata includes information about the physical position of the sensor when the data was recorded.

24. The method of claim 23 wherein the metadata includes information about a time associated with the recorded data.

25. The method of claim 20 wherein the second metadata includes one or more of atmospheric conditions including wind, temperature and precipitation and/or extensible structure for said metadata.

26. The method of claim 1 or claim 3 further comprising recording and transferring of recorded data that returns measurement data generated by the sensor instead of or in addition to audio data.

27. The method of claim 1 or claim 3 wherein the measurement data includes recording the results of other sensor modalities, including one or both of radiation and/or biological hazards.

28. The method of claim 1 or claim 3 further comprising storing audio and associated metadata on media removable from the sensor, wherein the stored data is 0configured to be accessed by an external computing mechanism to provide all of the data and metadata stored on the media.

29. The method of claim 1 or claim 3 further comprising storing audio and associated metadata on media having the capability for electrical transmission to a nearby external computing component such that the data can be retrieved.

30. The method of claim 1 or claim 3 further comprising providing an emergency-erase component actuated locally or remotely.

31. The method of claim 1 or claim 3 further comprising re-processing the recorded audio to extract additional information or features from past audio data.

32. A portable system that identifies an incident of interest in a region and creating an audio recording related thereto, the system comprising:
a sensor that detects acoustic signals;
a storage component associated with the sensor, wherein the storage component stores acoustic data received from the sensor;
one or more components that obtain a time-mark and a location associated with the sensor, wherein the time-mark includes a time synchronized to a common timebase;
a first processor associated with the sensor, wherein the first processor processes the acoustic signals to generate a processed signal comprising the acoustic data labeled with the time-mark and the location;
an annotation-providing component that causes the processor to further label the processed signal as containing acoustic data of interest
a communication component configured to transfer data including metadata about the detected acoustic signals to a second processor, the metadata including frequency domain information and/or angle of arrival information.

33. The portable system of claim 32 wherein the annotation-providing component includes computer-readable media containing computer-readable instructions including algorithms that provide instructions to the processor to label stored data as being of potential interest.

34. The system of claim 33 wherein the algorithms attempt to detect audio signatures of vehicles and instruct the processor to label associated data as being of interest.

35. The system of claim 32 wherein the annotation-providing component includes a component that is activated by a user or wearer of the system and labeling of data is initiated via voice command or physical interaction.

36. The system of claim 32 wherein the annotation-providing component includes a device that receives instructions from an external device that instructs the portable system to label data as being of interest.

37. The system of claim 32 wherein the further labeling of data is initiated by a person who communicates with the sensor via a communications mechanism, a voice or audio command, or a physical interaction.

38. The system of claim 32 further comprising a component actuated by a voice of the user or wearer of the portable system, wherein instructions to further label data are provided by the component via initiation by the user or wearer, and the processed who uses the sensor to record a voice message.

39. The system of claim 38, wherein the processor performs all noise detection processing within 30 seconds and deletes any audio data not identified as being of interest after that time.
